(19) United States
(12) Patent Application Publication
(10) Pub. No.: US 2022/0087357 A1
(43) Pub. Date: Mar. 24, 2022

(54) HELMET SHIELD AND HELMET COMPRISING SAME

(71) Applicant: DATECHNIQ INC., Seongnam-si (KR)

(72) Inventor: Hyoung Bin LIM, Seongnam-si (KP)

(73) Assignee: DATECHNIQ INC., Seongnam-si (KR)

(21) Appl. No.: 17/542,232

(22) Filed: Dec. 3, 2021

Related U.S. Application Data
(63) Continuation of application No. PCT/KR2020/016123, filed on Nov. 17, 2020.

(30) Foreign Application Priority Data
Dec. 17, 2019 (KR) 10-2019-0169066
Nov. 17, 2020 (KR) 10-2020-0153517

(51) Int. Cl. A42B 3/30; G02B 27/01

(52) U.S. Cl. CPC A42B 3/30; G02B 27/0172

(57) ABSTRACT

The present disclosure relates to a helmet shield which may be coupled to a helmet comprising an imaging device for outputting an image, the helmet shield including a flat plate-shaped display area for reflecting at least a portion of light projected from an imaging device so that the wearer visually recognizes an image, wherein the display area is formed so as to be continuous with another area of the helmet shield.

### CROSS-REFERENCE TO RELATED APPLICATION

The present application is a continuation of International Patent Application No. PCT/KR2020/016123, filed on Nov. 17, 2020, which is based upon and claims the benefit of priority to Korean Patent Application Nos. 10-2019-0169066 filed on Dec. 17, 2019 and 10-2020-0153517 filed on Nov. 17, 2020. The disclosures of the above-listed applications are hereby incorporated by reference herein in their entirety.

### BACKGROUND

### 1. Technical Field

The present disclosure relates to a helmet shield capable of displaying an image projected from an imaging device, and a helmet including the same.

### 2. Description of Related Art

In recent years, as vehicle head-up display (HUD) technology has been developed, a driver can focus on driving by looking ahead and checking an image required for driving simultaneously.

In particular, by allowing the driver to check navigation information through HUD technology, HUD technology is recognized as a useful technology for the driver in that it is possible to reduce accidents caused by not looking ahead while checking navigation information.

HUD technology is a kind of augmented reality-related technology, and attempts to apply such HUD technology to motorcycles rather than automobiles are continuing.

For example, a product that includes a display unit in a helmet worn by a motorcycle rider separately from a shield and allows the rider to check an image through the display unit is being released.

However, in the case of providing an image to the driver by installing a shield and a separate display unit in the helmet as described above, the volume of the helmet needs to be designed and manufactured to be larger than necessary for the installation of the display unit in the helmet, and a high level of technology is required to secure the viewing distance. To date, all related companies are experiencing difficulties in commercialization and mass production.

The above information described in this background section is only to enhance the understanding of the background of the present disclosure and therefore it may contain information that does not form the related art that is already known to a person having ordinary skill in the field to which this technology pertains.

### SUMMARY

An aspect of the present disclosure is directed to providing a helmet shield through which a helmet wearer of the helmet visually recognizes an image, and providing a helmet shield in which a display area is formed so as to be continuous with another area of the helmet shield, and a helmet including the helmet shield.

The aspects of the present disclosure are not limited to those mentioned above, and other aspects not mentioned herein will be clearly understood by those skilled in the art from the following description.

A helmet shield which may be coupled to a helmet including an imaging device for outputting an image includes a flat plate-shaped display area for reflecting at least a portion of light projected from the imaging device so that a wearer visually recognizes the image, wherein the display area is formed so as to be continuous with another area of the helmet shield.

A helmet shield which may be coupled to a helmet including an imaging device for outputting an image includes a flat plate-shaped display area for reflecting at least a portion of light projected from the imaging device so that a wearer visually recognizes the image, wherein the display area is formed so as to be continuous with another area of the helmet shield, and has a curve so that the wearer enlarges and visually recognizes the image.

In addition, curvature of the display area may be different from curvature of an area other than the display area of the helmet shield.

In addition, the curvature of the display area has a smaller value than the curvature of an area other than the display area of the helmet shield.

In addition, the display area may include a first surface and a second surface facing each other, and curvature of the first surface may be different from curvature of the second surface.

In addition, reflectivity of the display area may be different from reflectivity of an area other than the display area of the helmet shield.

In addition, the display area may include a reflection member.

In addition, an average thickness of the display area may be different from an average thickness of an area other than the display area of the helmet shield.

In addition, at least a portion of an area other than the display area of the helmet shield may be formed so as to be continuous while forming a predetermined angle with the display area.

A helmet according to an embodiment of the present disclosure includes: a helmet body having at least a portion thereof opened; a helmet shield according to any one of claims 1 to 5, attached to the helmet body so as to cover at least a portion of an opening of the helmet body; and an imaging device for projecting light to the display area.

In addition, the helmet shield does not cover a portion of an upper part of a front of the helmet.

According to an embodiment of the present disclosure, even when a separate display unit is not installed in the helmet, a wearer can check an image through a display area included in the helmet shield, so that the wearer can check a clear image with a simple configuration.

In addition, according to an embodiment of the present disclosure, since a partial area of the helmet shield is used as a display area without installing a separate display unit in a helmet, a wearer can check a clear image even without increasing a volume of the helmet.

In addition, according to an embodiment of the present disclosure, since a display area included in a helmet shield has a curve, a wearer can visually recognize an enlarged image.

The advantages of the present disclosure are not limited to those mentioned above, and other advantages not mentioned herein will be clearly understood by those skilled in the art from the following description.

### BRIEF DESCRIPTION OF THE DRAWINGS

FIG. 1 is a side view of a helmet including a helmet shield according to an embodiment of the present disclosure.

FIG. 2 is a cross-sectional view of the helmet of FIG. 1.

FIG. 3 is a perspective view of a display area according to an embodiment of the present disclosure included in FIG. 1.

FIGS. 4A to 5B are cross-sectional views of a display area according to another embodiment of the present disclosure.

FIG. 6 is a side view of a helmet including a helmet shield according to another embodiment of the present disclosure.

FIG. 7 is a perspective view of a helmet shield according to another embodiment of the present disclosure included in FIG. 6.

FIG. 8 is a perspective view of a helmet including a helmet shield according to another embodiment of the present disclosure.

### DETAILED DESCRIPTION

The advantages and features of the present disclosure and methods of achieving them will be apparent from the embodiments that will be described in detail with reference to the accompanying drawings. It should be noted, however, that the present disclosure is not limited to the following embodiments, and may be implemented in various different forms. Rather the embodiments are provided so that this disclosure will be thorough and complete and will fully convey the scope of the present disclosure to those skilled in the technical field to which the present disclosure pertains. It is to be noted that the scope of the present disclosure is defined only by the claims.

Terms used in the specification are used to describe embodiments of the present disclosure and are not intended to limit the scope of the present disclosure. In the specification, the terms of a singular form may include plural forms unless otherwise specified. The expressions “comprise” and/or “comprising” used herein indicate existence of one or more other elements other than stated elements but do not exclude presence of additional elements. Like reference denotations refer to like elements throughout the specification. As used herein, the term “and/or” includes each and all combinations of one or more of the mentioned components. It will be understood that, although the terms “first”, “second”, etc., may be used herein to describe various components, these components should not be limited by these terms. These terms are only used to distinguish one component from another component. Accordingly, a first component mentioned below could be termed a second component without departing from the technical ideas of the present disclosure.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

Hereinafter, the embodiments of the present disclosure will be described in detail with reference to the accompanying drawings.

Prior to the description, the meanings of the terms used in the present specification will be described briefly. However, it should be noted that the description of terms is used to help the understanding of the present specification, but is not to be used to limit the technical spirit of the present disclosure in the case where the limitative details of the present disclosure are not explicitly described.

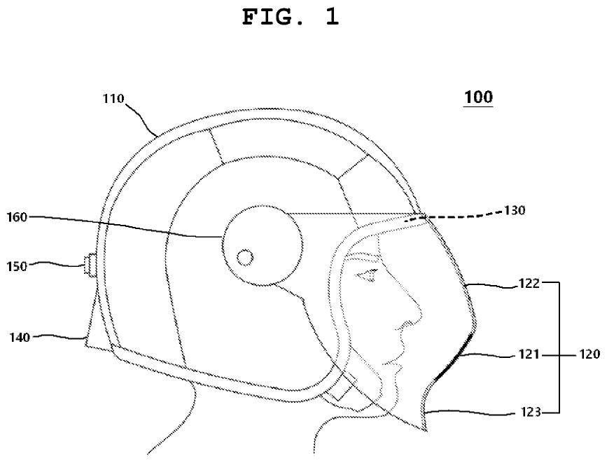

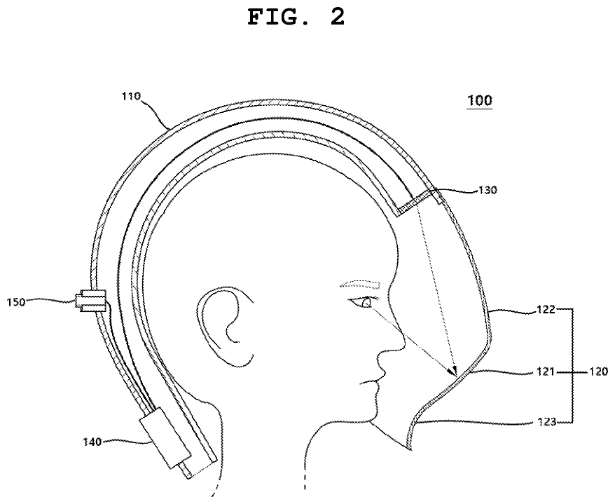

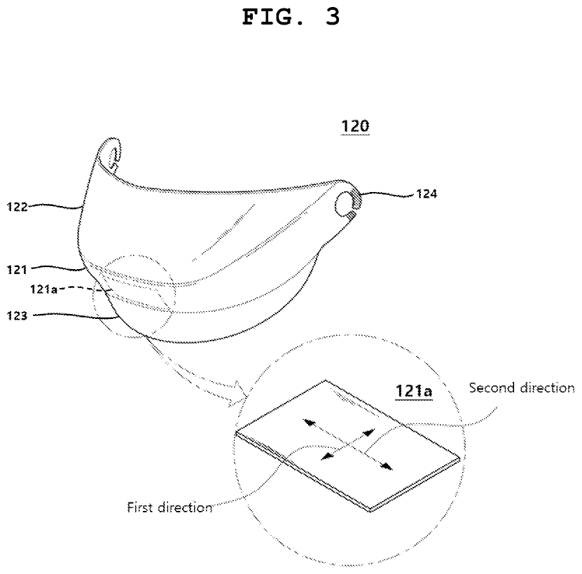

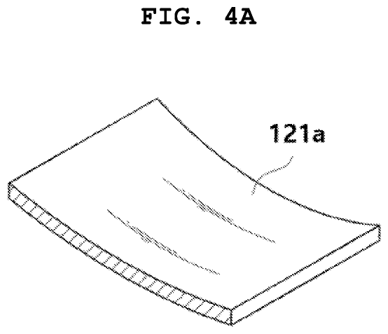

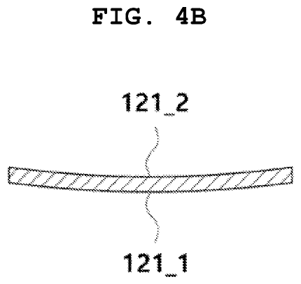

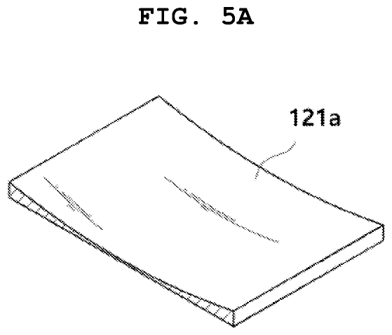

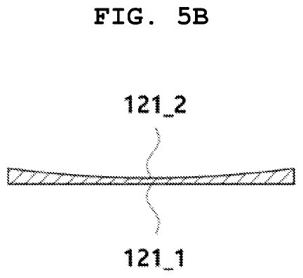

Hereinafter, a helmet 100 according to an embodiment of the present disclosure will be described with reference to FIGS. 1 to 5B. FIG. 1 is a side view of the helmet 100 including a helmet shield 120 according to an embodiment of the present disclosure. FIG. 2 is a cross-sectional view of the helmet 100 of FIG. 1. FIG. 3 is a perspective view of a display area 121a according to an embodiment of the present disclosure included in FIG. 1. FIGS. 4A to 5B are cross-sectional views of the display area 121a according to another embodiment of the present disclosure.

Referring to FIG. 1, the helmet 100 according to an embodiment of the present disclosure may include a helmet body 110, the helmet shield 120, an imaging device 130, a control module 140, a rear sensor 150, and a manipulation module 160. However, in certain embodiments, the helmet 100 may include a relatively larger number or a relatively smaller number of components than the above-described components.

Referring to FIG. 2, in a state in which a wearer wears the helmet 100 according to an embodiment of the present disclosure, light is projected on the helmet shield 120 through the imaging device 130 and the wearer may check an image by visually recognizing the light reflected from the helmet shield 120.

The helmet body 110 has at least a portion thereof opened, and thus may be worn on the head of a wearer. The helmet shield 120, the imaging device 130, the control module 140, the rear sensor 150, and the manipulation module 160 may be mounted or included in the helmet body 110.

However, in certain embodiments, the helmet body 110 may be replaced with a wearable device of various shapes that may be worn on the head of a wearer in addition to a helmet. For example, a hair band may be used instead of the helmet body 110 as the wearable device, but is not limited thereto.

The helmet shield 120 is formed to be coupled to the helmet 100, and specifically, is attached to the helmet body 110 so as to cover at least a portion of the opening of the helmet body 110. Referring to FIG. 3, the helmet shield 120 may include a coupling area 124 for coupling with the helmet 100, and the coupling area 124 may have, for example, a shape in which at least a portion thereof is opened, but is not limited thereto.

Referring to FIG. 2, when a wearer wears the helmet 100, the helmet shield 120 is positioned in front of the wearer's face. The helmet shield 120 may be formed of a transparent or translucent material to secure a view of a wearer.

Specifically, referring to FIGS. 1 to 3, the helmet shield 120 according to an embodiment of the present disclosure may include a first shield area 121, a second shield area 122, and a third shield area 123. The first shield area 121 may be defined as an area including the display area 121a, the second shield area 122 may be defined as an area that does not include the display area 121a and is formed above the first shield area 121 relatively in the helmet shield 120, and the third shield area 123 may be defined as an area that does not include the display area 121a and is formed below the first shield area 121 relatively in the helmet shield 120.

For example, the helmet shield 120 is formed by positioning the first shield area 121 between the second shield area 122 and the third shield area 123. When a wearer wears the helmet 100 including the helmet shield 120, the second shield area 122 is positioned around the eyes and nose of the wearer, so that the wearer can check the outside through the second shield area 122.

The first shield area 121 is positioned around the nose and mouth of a wearer, so that the wearer can check an image through the display area 121a included in the first shield area 121 without being obstructed from securing an external view. In other words, the first shield area 121 may be formed downward from a point below a predetermined distance when the helmet shield 120 is worn on the helmet 100. As another example, it may be formed downward from a point corresponding to a nose height vicinity of the wearer. In this connection, the first shield area 121 may be formed at an angle different from the general helmet 100 shield, and preferably, as shown in FIG. 2, when the wearer wears the helmet 100 and looks forward or downward in a state where the wearer looks forward, it may be formed to be nearly perpendicular to one's gaze.

The third shield area 123 may be positioned around the mouth and chin of a wearer so that moisture coming from the nose or mouth of the wearer may be discharged from the third shield area 123.

In certain embodiments, the first shield area 121 and the second shield area 122 may be formed separately.

The display area 121a is an area on which light is projected from the imaging device 130 of the helmet shield 120. The display area 121a is a partial area of the helmet shield 120 and may be formed so as to be continuous with another area of the helmet shield 120. Specifically, the first shield area 121 included in the display area 121a may be formed so as to be continuous with the second shield area 122 and the third shield area 123, and the display area 121a may be formed so as to be continuous with an area other than the display area 121a in the first shield area 121.

Referring to FIG. 2, the display area 121a reflects at least a portion of the light projected from the imaging device 130 to allow a wearer to visually recognize an image. For effective reflection of the display area 121a, the display area 121a may include a reflection member (not shown) or may be formed of a material having relatively high reflectivity.

For example, the inside or outside of the display area 121a may be coated with a reflection member (not shown) such as a reflective film, but is not limited thereto.

The reflectivity of the display area 121a may be, for example, between 10% and 90%. When the reflectivity of the display area 121a is 10% or less, it is difficult for a wearer to clearly recognize an image through the light reflected from the display area 121a. When the reflectivity of the display area 121a is 90% or more, the reflected screen blocks a front view of the wearer, thereby adversely affecting safety.

In certain embodiments, the reflectivity of the display area 121a may be different from the reflectivity of an area other than the display area 121a in the helmet shield 120, and the reflectivity of the display area 121a may be relatively higher than the reflectivity of an area other than the display area 121a in the helmet shield 120. In other words, the reflectivity of the first shield area 121 included in the display area 121a may be relatively higher than that of the second shield area 122 and the third shield area 123.

However, in certain embodiments, even within the first shield area 121, the reflectivity of an area other than the display area 121a and the display area 121a may be different, and the reflectivity of the display area 121a may be relatively higher than that of an area other than the display area 121a.

Thus, according to the helmet shield 120 according to an embodiment of the present disclosure, the light projected from the imaging device 130 is not well reflected, other than from the display area 121a, so that a wearer can focus on a clear image and view the outside well without being disturbed by the reflected image.

The display area 121a needs to have relatively high reflectivity compared to another area of the helmet shield 120 for light reflection. To this end, as described above, the display area 121a of the shield 120 may include a reflection member (not shown). In this connection, an average thickness of the display area 121a may be different from an average thickness of an area other than the display area 121a of the helmet shield 120, and a thickness of the first shield area 12a included in the display area 121a may be thicker than a thickness of the second shield area 122 due to the reflection member (not shown).

In certain embodiments, an anti-reflection member (not shown) may be included in an area other than the display area 121a, that is, the second shield area 122 and the third shield area 123. For example, the inside or outside of the second shield area 122 and the third shield area 123 may be coated with an anti-reflection member (not shown) such as an anti-reflection film, or the inside or outside of an area other than the display area 121a of the first shield area 121 may be coated with an anti-reflection member (not shown) such as an anti-reflection film, but is not limited thereto. Thus, according to the helmet shield 120 according to an embodiment of the present disclosure, the light projected from the imaging device 130 is not well reflected other than from the display area 121a, so that a wearer can view a clear image.

Referring to FIGS. 1 to 3, the display area 121a may have a flat plate shape, and in certain embodiments, the display area 121a may be substantially planar. For example, all of the cross-sections perpendicular to each other of the display area 121a may be flat. Referring to FIG. 3, both the cross-section in the first direction and the cross-section in the second direction perpendicular to the first direction of the display area 121a may be flat.

Since the display area 121a has a flat plate shape, by minimizing the refraction of the light projected from the imaging device 130, a wearer can also view the outside well through the second shield area 122 without being disturbed by the reflected image while viewing a clear image through the display area 121a.

In certain embodiments, referring to FIGS. 4A to 5B, the display area 121a may have a curve so that a wearer may enlarge and visually recognize an image of the imaging device 130. In other words, since the display area 121a has a curve, a lens function (for example, a concave lens) for magnifying an image may be performed. Accordingly, according to the helmet shield 120 according to an embodiment of the present disclosure, even when a separate configuration for magnifying an image is not included in the imaging device 130, the wearer can check the enlarged image through the display area 121a, thereby increasing the visibility of the wearer.

The display area 121a may form a curve in at least a partial area along at least one direction of a first direction (see FIG. 3) or a second direction perpendicular to the first direction (see FIG. 3). In other words, a curve may be formed along at least one direction of a first direction and a second direction perpendicular to each other on a plane formed by the display area 121a.

However, the curve formed in the display area 121a is different from the curve formed in an area other than the display area of the helmet shield 120 in terms of the purpose of forming the curves and the curvature.

Specifically, in general, since the helmet shield 120 is formed to cover at least a portion of the opening of the helmet body 110 having a spherical shape, it often has a curve, and also often has a curve so that the helmet shield 120 receives less wind resistance in the riding process.

On the other hand, the curve formed in the display area 121a is not a shape of the helmet body 110 or a shape resulting from wind resistance, but is formed for the purpose of magnifying an image.

Accordingly, the curvature of the display area 121a in the helmet shield 120 according to an embodiment of the present disclosure is different from the curvature of an area other than the display area 121a in the helmet shield 120. Specifically, the curvature of the display area 121a may have a smaller value than the curvature of an area other than the display area 121a in the helmet shield 120. In other words, the curvature of the display area 121a is different from the curvature of the second shield area 122 and the third shield area 123, and the curvature of the display area 121a may have a smaller value than the curvature of the second shield area 122 and the third shield area 123. In addition, the curvature of the display area 121a may have a smaller value than the curvature of an area other than the display area 121a in the first shield area 121.

The difference between the curvature of the display area 121a in the helmet shield 120 according to an embodiment of the present disclosure and the curvature of an area other than the display area 121a in the helmet shield 120 means that the curvature in the first direction (see FIG. 3) of the display area 121a is different from the curvature in the first direction of an area other than the display area 121a in the helmet shield 120 or that the curvature in the second direction (see FIG. 3) of the display area 121a is different from the curvature in the second direction of an area other than the display area 121a in the helmet shield 120.

Specifically, the curvature in the first direction of the display area 121a may be smaller than the curvature in the first direction of an area other than the display area 121a in the helmet shield 120 or the curvature in the second direction of the display area 121a may be smaller than the curvature in the second direction of an area other than the display area 121a in the helmet shield 120.

Referring to FIGS. 4A and 4B, the display area 121a may have a curve in a situation having the same thickness. However, in certain embodiments, referring to FIGS. 5A and 5B, the thickness of the display area 121a may not be uniform. Specifically, the display area 121a includes a first surface 121_1 and a second surface 121_2 facing each other, and the curvature of the first surface 122a and the curvature 122b of the second surface may be different.

For example, the display area 121a may be subjected to additional processing on only one of the first surface 121_1 and the second surface 121_2 so that the first surface 121_1 and the second surface 121_2 have different curvatures, but is not limited thereto.

In certain embodiments, any one surface of the first surface 121_1 and the second surface 121_2 of the display area 121a may have the same or continuous curvature as the second shield area 122 and the third shield area 123. The other surface of the first surface 121_1 and the second surface 121_2 of the display area 121a may have a different curvature from the second shield area 122 and the third shield area 123.

In certain embodiments, any one surface of the first surface 121_1 and the second surface 121_2 of the display area 121a may have the same or continuous curvature as an area other than the display area 121a in the first shield area 121. The other surface of the first surface 121_1 and the second surface 121_2 of the display area 121a may have a different curvature from an area other than the display area 121a in the first shield area 121.

As such, when the first surface 121_1 and the second surface 121_2 of the display area 121a have different curvatures, the average thickness of the display area 121a may be different from the average thickness of an area other than the display area 121a in the helmet shield 120. In other words, the thickness of the first shield area 121 including the display area 121a may be different from the thickness of the second shield area 122. In certain embodiments, a thickness of the display area 121a may be different from a thickness of an area other than the display area 121a in the first shield area 121.

On the other hand, referring to FIGS. 1 and 2, in the vertical cross-section of the helmet shield 120, at least a portion of an area other than the display area 121a may form a predetermined angle with the display area 121a and be formed so as to be continuous. For example, at least a portion of an area other than the display area 121a may form an obtuse angle with the display area 121a, but is not limited thereto.

Specifically, in the vertical cross-section of the helmet shield 120, the display area 121a may form an obtuse angle with the second shield area 122 and may also form an obtuse angle with the third shield area 123. The second shield area 122, the display area 121a, and the third shield area 123 may be continuously connected to form a concavity and convexity or an S-shaped curve.

In a situation where the imaging device 130 is positioned near a forehead of a wearer, at least a portion of an area other than the display area 121a forms an obtuse angle with the display area 121a, and thus the display area 121a may receive light close to vertical light from the imaging device 130. In addition, by minimizing the loss of light projected from the imaging device 130 positioned in forehead or eye region, the light can be reflected from the display area 121a toward the eyes of the wearer.

In addition, since the display area 121a and the third shield area 123 form an obtuse angle so that the third shield area 123 moves away from a wearer, and an opening may be formed in the helmet shield 120 therethrough, moisture generated by the mouth and nose of the wearer may escape to the outside of the helmet shield 120 without being formed on the display area 121a.

In an embodiment of the present disclosure, the imaging device 130 may be formed inside the helmet body 110. More specifically, as shown in FIG. 2, the imaging device 130 may be provided on the upper side of the inner front surface of the helmet body 110, that is, at a position corresponding to the vicinity of the forehead of a wearer.

The imaging device 130 may irradiate light toward the display area 121a as shown in FIG. 2, but is not limited thereto. The light irradiated from the imaging device 130 may be directly projected onto the display area 121a. In certain embodiments, the light reflected through at least one reflector (not shown) may be projected.

For example, in FIG. 2, the light irradiated from the imaging device 130 is directly projected onto the display area 121a. However, when it is difficult to design the imaging device 130 to be directly projected due to the structure of the helmet 100, a reflector (not shown) may be provided inside the helmet 100, and the light irradiated from the imaging device 130 may be projected onto the display area 121a via the reflector.

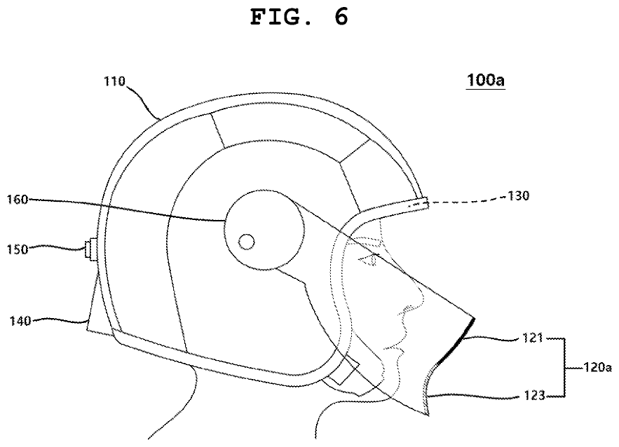

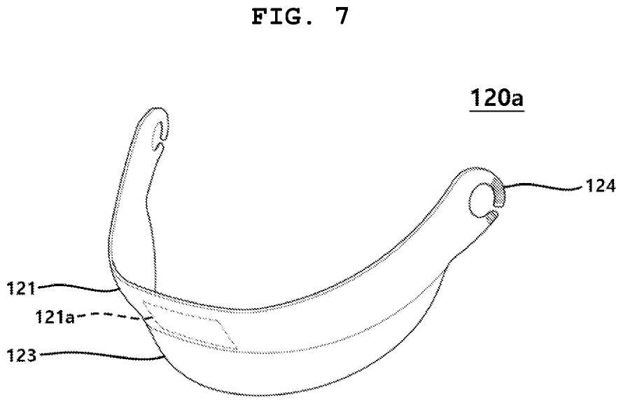

Hereinafter, a helmet 100a according to another embodiment of the present disclosure will be described with reference to FIGS. 6 and 7. However, differences from the helmet 100 according to an embodiment of the present disclosure will be mainly described. FIG. 6 is a side view of a helmet 100a including a helmet shield 120a according to another embodiment of the present disclosure, and FIG. 7 is a perspective view of a helmet shield 120a according to another embodiment of the present disclosure included in FIG. 6.

Referring to FIGS. 6 and 7, the helmet shield 120a according to an embodiment of the present disclosure does not include the second shield area 122. Accordingly, even when a wearer wears the helmet 100a, the eye region of the wearer is not protected by the helmet shield 120a, but the wearer may check an image without any difficulty through the display area 121a.

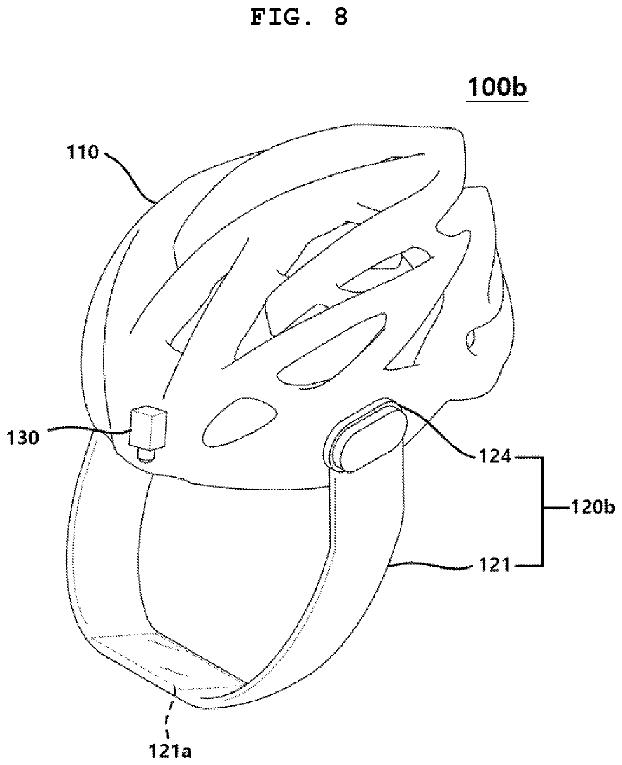

Hereinafter, a helmet 100b according to another embodiment of the present disclosure will be described with reference to FIG. 8. However, differences from the helmet 100 according to an embodiment of the present disclosure will be mainly described. FIG. 8 is a perspective view of a helmet 100b including a helmet shield 120b according to another embodiment of the present disclosure.

Referring to FIG. 8, the helmet 100b according to another embodiment of the present disclosure includes the helmet body 110 for a bicycle, and the helmet shield 120b according to another embodiment of the present disclosure includes the first shield area 121, but does not include the second shield area 122 and the third shield area 123. The imaging device 130 is externally installed on the helmet 100b, but is not limited thereto.

According to the embodiments of the present disclosure described above, by providing a projection function of the imaging device 130 through the display area 121a of the first shield area 121, the forward gaze of a helmet 100 wearer is not obstructed at all, and various types of information are provided. Thus, the present disclosure exhibits a remarkably superior effect compared to other helmets in that it increases the convenience of production by using the existing configuration without introducing an additional display unit and without excessively increasing the size of the helmet 100.

Hereinbefore, the present disclosure has been described with reference to the embodiments. It will be understood by those having ordinary skill in the technical field to which the present disclosure pertains that the present disclosure may be embodied in various other specific forms without departing from the technical ideas or essential characteristics thereof. Therefore, the disclosed embodiments should be considered in an illustrative rather than a restrictive perspective in all aspects.

### DESCRIPTION OF REFERENCE NUMERALS

100, 100a, 100b: HELMET
110: HELMET BODY
120: HELMET SHIELD
121: FIRST SHIELD AREA
121A: DISPLAY AREA
122 SECOND SHIELD AREA
123: THIRD SHIELD AREA
124: COUPLING AREA
130: IMAGING DEVICE
140: CONTROL MODULE
150: REAR SENSOR
160: MANIPULATION MODULE

1. A helmet shield disposed on a forehead region of a wearer and coupled to a helmet, including an imaging device for outputting an image therein, the helmet shield including:
a flat plate-shaped display area disposed on a lower side of the imaging device and reflecting at least a portion of light projected from an upper side thereof so that the wearer visually recognizes an image, wherein:
the display area and another area of the helmet shield forming a boundary with the display area are continuously connected to each other and integrally formed, and
at least a partial area of the display area is formed with a curve in a first direction and a second direction perpendicular to each other.

2. A helmet shield disposed on a forehead region of a wearer and coupled to a helmet, including an imaging device for outputting an image therein, the helmet shield including:
a display area disposed on a lower side of the imaging device and reflecting at least a portion of light projected from an upper side thereof so that the wearer visually recognizes an image, wherein:
the display area and another area of the helmet shield forming a boundary with the display area are continuously connected to each other and integrally formed, and
at least a partial area of the display area is formed with a curve in a first direction and a second direction perpendicular to each other.

3. The helmet shield according to claim 2, wherein curvature of the display area is different from curvature of an area other than the display area of the helmet shield.

4. The helmet shield according to claim 3, wherein the curvature of the display area has a smaller value than the curvature of an area other than the display area of the helmet shield.

5. The helmet shield according to claim 3, wherein the display area includes a first surface and a second surface facing each other, and curvature of the first surface is different from curvature of the second surface.

6. The helmet shield according to claim 1, wherein reflectivity of the display area is different from reflectivity of an area other than the display area of the helmet shield.

7. The helmet shield according to claim 6, wherein the display area includes a reflection member.

8. The helmet shield according to claim 1, wherein an average thickness of the display area is different from an average thickness of an area other than the display area of the helmet shield.

9. The helmet shield according to claim 1, wherein at least a portion of an area other than the display area of the helmet shield is formed so as to be continuous while forming a predetermined angle with the display area.

10. A helmet including:
a helmet body having at least a portion thereof opened;
a helmet shield according to claim 1, attached to the helmet body so as to cover at least a portion of an opening of the helmet body; and
an imaging device for projecting light to the display area.

11. The helmet according to claim 10, wherein the helmet shield does not cover a portion of an upper part of a front of the helmet.

12. The helmet shield according to claim 1, wherein the helmet shield includes:
a first shield area including the display area and gradually approaching the wearer in a direction toward a lower side; and
a third shield area continuously formed with the first shield area at a lower side of the first shield area and gradually moving away from the wearer in a direction toward the lower side.

13. The helmet shield according to claim 1, wherein the helmet shield includes:
a first shield area including the display area and gradually approaching the wearer in a direction toward a lower side; and
a second shield area continuously formed with the first shield area at an upper side of the first shield area and gradually moving away from the wearer in a direction toward the lower side.
